(19) United States
(12) Patent Application Publication
(10) Pub. No.: US 2021/0234569 A1
(43) Pub. Date: Jul. 29, 2021

(54) DEVICE CASE COMPRISING TRACK SYSTEM AND METHOD OF MAKING AND USING THE SAME

(71) Applicants: Kristopher Jon Soderstrom, Raleigh, NC (US); Siegfried Lauren, Chapel Hill, NC (US)

(72) Inventors: Kristopher Jon Soderstrom, Raleigh, NC (US); Siegfried Lauren, Chapel Hill, NC (US)

(21) Appl. No.: 16/897,621

(22) Filed: Jun. 10, 2020

Related U.S. Application Data
(60) Provisional application No. 62/966,392, filed on Jan. 27, 2020.
(60) Provisional application No. 62/966,380, filed on Jan. 27, 2020.

(51) Int. Cl. H04B 1/3888; G06F 1/16

(52) U.S. Cl. CPC H04B 1/3888; G06F 1/1656; G06F 1/1626; G06F 1/1632

(57) ABSTRACT

The presently disclosed subject matter is generally directed to a device case that provides for removable attachment of one or more accessories. Specifically, the attachment case comprises one or more tracks that allow a variety of accessories to be attached and/or removed as desired by the user. In this way, one or more accessories can be added, removed, oriented, and/or arranged depending on a particular use of the device. Advantageously, each accessory locks into place on the track such that it is fully supported. In this way, one or more accessories can be releasably attached to a device case as desired by the user. Using the rail system along with electronics embedded in the case, the case has the capability of interacting with accessories through sensing, actuation, and control in order to describe and analyze a situation, and make decisions based on the available data in a predictive or adaptive manner, thereby performing smart actions

### CROSS-REFERENCE TO RELATED APPLICATIONS

This application claims priority to U.S. Provisional Application Nos. 62/966,392 and 62/966,380, both filed Jan. 27, 2020, the entire contents of which are hereby incorporated by reference herein.

### TECHNICAL FIELD

The presently disclosed subject matter is generally directed to a device case comprising a track system for the releasable attachment of one or more accessories and, in some embodiments, allowing the accessories to be electrically connected to the device through the track system. The presently disclosed subject matter further includes methods of making and using the disclosed case.

### BACKGROUND

Portable electronic devices (such as cell phones) have become a primary communication device for a large portion of the public. Cell phone cases are used by most consumers that have cell phones to provide a degree of protection in the event of an impact, such as dropping the phone. Moreover, the case can protect the screen or camera lens by providing a ledge that will keep the surface raised. In addition to their phones, it is common for people to carry additional items and/or accessories when they leave their home, such as wallets, keys, writing utensils, and the like. As the number of accessories that a person carries increases, the more difficult it becomes to safely and securely carry each item. Currently, most users carry their cell phone and accessories in separate pockets or within separate compartments of a bag, purse, or briefcase. When a user desired to access a phone and/or accessory, he or she must rummage around to find the desired item. This can be time consuming and inconvenient. Furthermore, when a user carries multiple accessories, there is an increased likelihood that one or more items will be misplaced or dropped. It would therefore be beneficial to provide a device case that allows for the customizable attachment and detachment of one or more accessories.

### SUMMARY

In some embodiments, the presently disclosed subject matter is directed to a device case. Particularly, the case comprises a body comprising an outer perimeter, and a sidewall attached to and extending about the outer perimeter of the body to define a recess, an inner case wall, and an outer case wall. The case further includes at least one track attached to the outer case wall, wherein the track comprises a pair of parallel ridges on either side of a groove. Each pair of ridges comprises at least one recess. The groove is sized and shaped to releasably receive a protrusion positioned on an accessory, such that the accessory is locked into a desired position on the track, and the accessory is releasably received within the groove at any desired location on the at least one track.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the case comprises at least one electrical contact area along the at least a portion of the length of the track.

In some embodiments, the at least one electrical contact area can send or receive data through direct connection with the device.

In some embodiments, the tracks are permanently attached to the outer case wall.

In some embodiments, the electrical contact area includes at least one contact track manufactured on a printed circuit board, microprocessor, or both.

In some embodiments, the case comprises two or more tracks arranged parallel, perpendicularly, or angled relative to at least one other track.

In some embodiments, the groove has a T, triangular, trapezoidal, round, squared, diamond, pentagonal, hexagonal, cross, or abstract cross-sectional shape.

In some embodiments, the groove is configured to allow the protrusion to be inserted in a horizontal or vertical orientation.

In some embodiments, the presently disclosed subject matter is directed to a system comprising a device case defined by a body comprising an outer perimeter, and a sidewall attached to and extending about the outer perimeter of the body to define a recess, an inner case wall, and an outer case wall. The case includes a track attached to the outer case wall, wherein the track comprises a pair of parallel ridges on either side of a groove; and wherein each pair of ridges comprises at least one recess. The system includes a protrusion attached to an accessory, wherein the protrusion is sized and shaped to be releasably received within the groove, and wherein the at least one recess locks the protrusion into position within the groove. The accessory is releasably received within the groove at any desired location on the at least one track.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the system comprises at least one electrical contact area along the at least a portion of the length of the track.

In some embodiments, the at least one electrical contact area comprises at least one spring-loaded contact.

In some embodiments, the system comprises two or more tracks arranged parallel, perpendicularly, or angled relative to at least one other track.

In some embodiments, the groove is configured to allow the protrusion to be inserted in a horizontal or vertical orientation.

In some embodiments, the presently disclosed subject matter is directed to a method of releasably attaching one or more accessories to a device case. The method comprises attaching a protrusion to an accessory to be releasably attached to a device case, wherein the protrusion is sized and shaped to be received within the groove of a device case. The device case comprises: a body comprising an outer perimeter; a sidewall attached to and extending about the outer perimeter of the body to define a recess, an inner case wall, and an outer case wall; and a track attached to the outer case wall, wherein the track comprises a pair of parallel ridges on either side of a groove; wherein each pair of ridges comprises at least one recess. The method includes removably positioning the protrusion within the groove of the track ridge, wherein the at least one recess locks the protrusion in place on the track for a desired amount of time.

In some embodiments, the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

In some embodiments, the groove has a T, triangular, trapezoidal, round, squared, diamond, pentagonal, hexagonal, cross, or abstract cross-sectional shape.

In some embodiments, the groove is configured to allow the protrusion to be inserted in a horizontal or vertical orientation.

In some embodiments, the device case comprises at least one electrical contact area along the at least a portion of the length of the track.

In some embodiments, the at least one electrical contact area comprises at least one spring-loaded contact.

### BRIEF DESCRIPTION OF THE DRAWINGS

FIG. 1a is a top plan view of a device case in use in accordance with some embodiments of the presently disclosed subject matter.

FIG. 1b is a side plan view of the case of FIG. 1a.

FIG. 2a is a perspective view of a device case in accordance with some embodiments of the presently disclosed subject matter.

FIG. 2b is a bottom plan view of a device case in accordance with some embodiments of the presently disclosed subject matter.

FIG. 2c is a top plan view of a device case in accordance with some embodiments of the presently disclosed subject matter.

FIGS. 3a and 3b are top plan views of track designs in accordance with some embodiments of the presently disclosed subject matter.

FIGS. 4a and 4b are top plan views of device cases comprising tracks in various configurations in accordance with some embodiments of the presently disclosed subject matter.

FIG. 4c is a fragmentary view of a case comprising tracks in an angled configuration in accordance with some embodiments of the presently disclosed subject matter.

FIG. 5a is a side plan view of a case comprising sidewall tracks in accordance with some embodiments of the presently disclosed subject matter.

FIG. 5b is a side plan view of an accessory comprising an accessory track for the attachment of one or more accessories thereto.

FIG. 6a is a top plan view of a track system in accordance with some embodiments of the presently disclosed subject matter.

FIG. 6b is a cross-sectional view of a track system in accordance with some embodiments of the presently disclosed subject matter.

FIG. 7a-7j are cross-sectional views of track systems in accordance with some embodiments of the presently disclosed subject matter.

FIG. 8 is a top plan view of a device case in use in accordance with some embodiments of the presently disclosed subject matter.

FIGS. 9a-9d are fragmentary views of device tracks comprising one or more electrical connections.

FIGS. 10a and 10b are fragmentary views of case tracks in accordance with some embodiments of the presently disclosed subject matter.

FIG. 11a is a fragmentary view of an accessory comprising a protrusion in accordance with some embodiments of the presently disclosed subject matter.

FIG. 11b is a cross-sectional view of an accessory comprising two protrusions in accordance with some embodiments of the presently disclosed subject matter.

FIG. 12a is a bottom plan view of a device configured with a case in accordance with some embodiments of the presently disclosed subject matter.

FIG. 12b is a top plan view of a device configured with a case in accordance with some embodiments of the presently disclosed subject matter.

FIG. 12c is a side plan view of an accessory comprising a protrusion in accordance with some embodiments of the presently disclosed subject matter.

FIGS. 12d and 12e illustrate insertion of the accessory protrusion in the case track groove in accordance with some embodiments of the presently disclosed subject matter.

FIGS. 13a and 13b are top plan views illustrating a case with one or more attached accessories in accordance with some embodiments of the presently disclosed subject matter.

FIGS. 14a and 14b are side plan views illustrating a track and/or rail locking system in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+/−1%, in some embodiments+/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

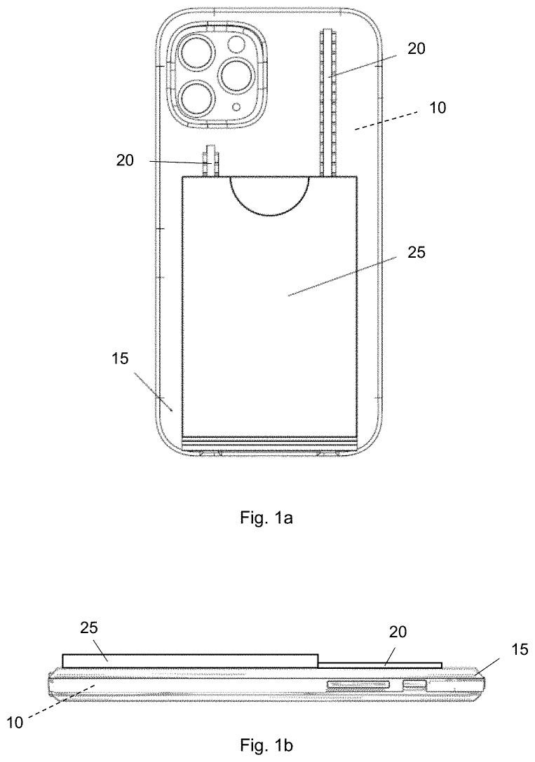

The presently disclosed subject matter is generally directed to a device case that provides for removable attachment of one or more accessories. FIGS. 1a and 1b illustrate one embodiment of a protective case used with device 10. Specifically, case 15 comprises one or more tracks 20 that allow a variety of accessories 25 to be attached and/or removed as desired by the user. In this way, one or more accessories can be added, removed, oriented, and/or arranged depending on a particular use of the device. Advantageously, each accessory locks into place on track 20 such that it is fully supported, as described in more detail herein below.

As set forth above, the disclosed attachment system includes case 15 used with device 10. The term “device” broadly refers to any of a wide variety of devices, including (but not limited to) cellular phones, smart phones, tablets, laptop computers, handheld gaming devices, GPS units, portable music players, gaming consoles, e-readers, cameras, digital cameras, smart watches, personal digital assistants, and the like. In some embodiments, device 10 is portable and can be carried in a user's hand or with a user's belongings (purse, briefcase, vehicle, etc.).

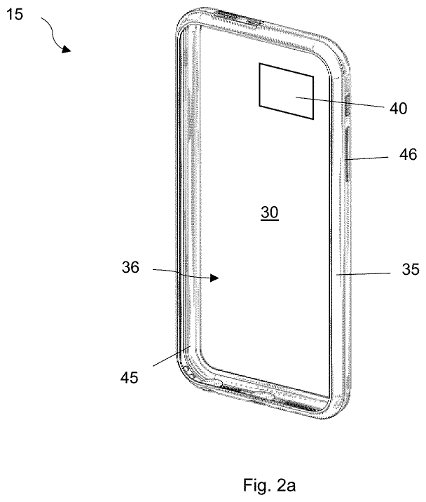

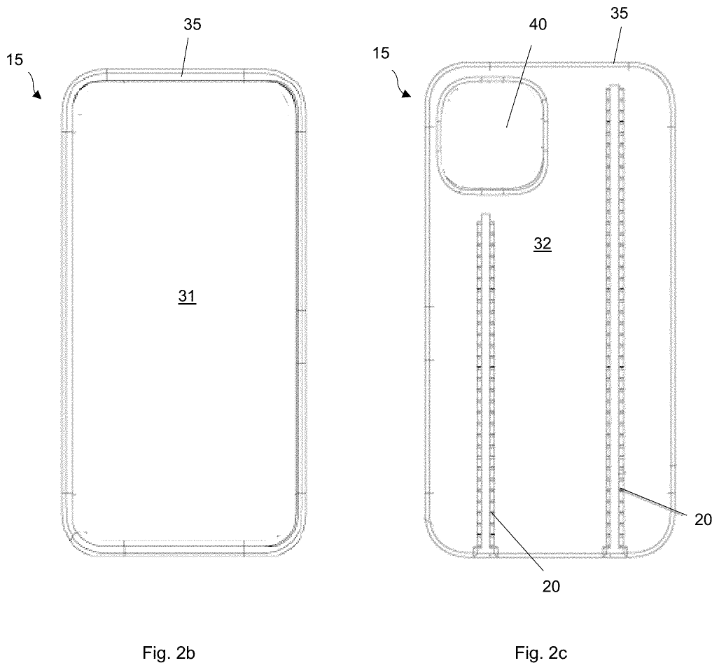

FIGS. 2a-2c illustrate one embodiment of case 15 that provides an overall enclosure and protection of device 10. Particularly, the case comprises panel 30 and sidewall 35 that join together to form cavity 36. Cavity 36 is sized and dimensioned to receive device 10. Panel 30 comprises inner face 31, opposing outer face 32, and two pairs of parallel side edges. Inner face 31 directly contacts one surface (e.g., the rear face) of a corresponding device. The panel outer face forms an exterior surface of the case. In some embodiments, the “rear face of a device” can refer to the face that the user does not interact with. For example, the rear face of a smart phone is the face opposite the viewing screen. The panel is sized and shaped to conform to the back face of device 10. Thus, panel 30 can be substantially flush against the back face of a device.

In some embodiments, panel 30 can include at least one aperture 40 sized and shaped to accommodate a corresponding feature in device 10. For instance, the aperture can be configured to align with a camera lens located on the rear face of the device when the device is seated within the case. It should be appreciated that aperture 40 can be positioned at any suitable location and can be configured in any desired shape and size. Further, any number of apertures can be included on case 15. However, it should be appreciated that aperture 40 is optional and the disclosed case can be configured without an aperture.

Sidewall 35 is formed about the perimeter of panel 30 to retain the device within the case. In some embodiments, sidewall 35 can include groove 45 configured to receive and retain a lateral edge of device 10. In this way, the sidewall prevents device 10 from inadvertently being removed from the case. The sidewall can include at least one access 46 that allows a user to interact with a control button (e.g., volume, charging port) on the lateral edge of the device when the device is seated within case 15. Access 46 can be formed as an aperture, a raised portion, and/or a recessed portion. In this way, a user can interact with buttons and other functional elements of the device through case 15 as needed. For example, the access can be respectively associated with a power button and one or more volume buttons provided on a device (e.g., a tablet computer).

Case 15 can be constructed from any desired material. For example, the case can be constructed from silicone, polymeric material, rubber, metal, fiberglass, wood, fabric, or combinations thereof.

The case can be constructed using any suitable method known in the art, including (but not limited to) injection molding, blow molding, extrusion, coextrusion, compression molding, welding, and the like.

In some embodiments, the case can be constructed as a single piece that fits around device 10. In other embodiments, the case can be constructed from two or more pieces that releasably or permanently join together around the device.

As set forth above, at least one face of case 15 includes one or more tracks 20. The term “tracks” broadly refers to any attachment element that allows for the releasable coupling and/or locking of one or more accessories. In some embodiments, each track 20 is permanently attached to one face of case 15, such as outer face 32. The track can be permanently attached using any known method, such as (but not limited to) the use of adhesive, welding, thermoforming, mechanical elements (e.g., screws, bolts, clips), or combinations thereof. Thus, in some embodiments, the tracks are integrated into the case.

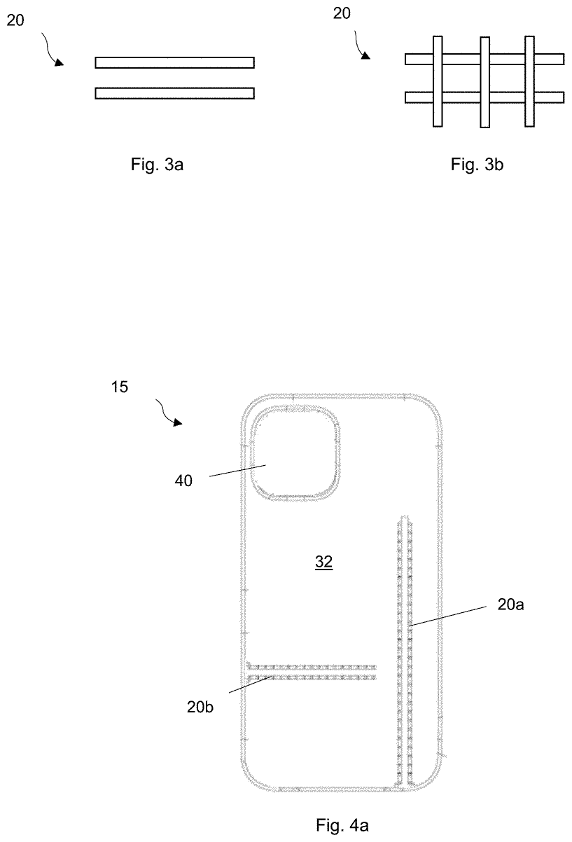

Alternatively, track 20 can be releasably attached to the case, such as in embodiments wherein only one track or a portion of one track is needed. The track can be releasably attached to the case using any known method, such as (but not limited to) the use of magnets, hook-and-loop closures, snaps, and the like. In this way, the location of track 20 can be customized by the user as desired or needed for a particular application. Thus, if a user intends to only carry a single small accessory, he can attach a correspondingly-sized track to rear face 32. Therefore, a user can customize tracks 20 as desired (e.g., both horizontal and vertical tracks added as needed for a selected number of accessories), as shown in FIGS. 3a and 3b. In this way, existing cases can be easily retrofit to include tracks for the releasable attachment of accessories.

Tracks 20 can be constructed from any desired rigid or semi-rigid material, such as (but not limited to) metal (e.g., stainless steel, aluminum, copper), polymeric material, wood, composite material, or combinations thereof.

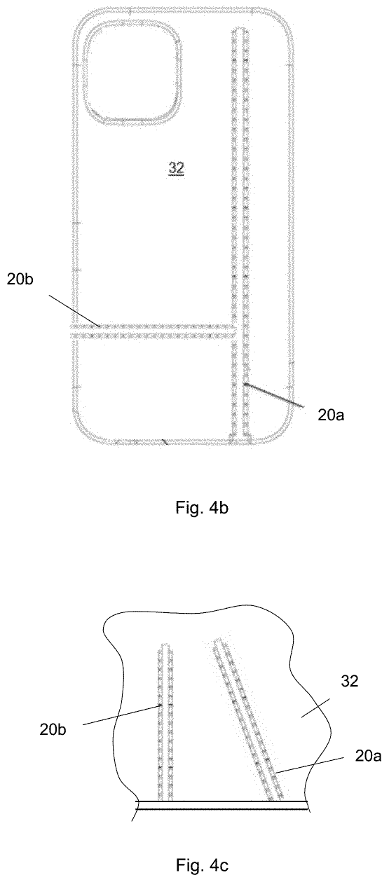

Case 15 can include any desired number of tracks 20. For example, in some embodiments, the case can include 1-10 tracks (e.g., 1, 2, 3, 4, 5, 6, 7, 8, 9, or 10). However, the presently disclosed subject matter is not limited and the case can have more than 10 tracks. When case 15 includes more than one track, the tracks can be arranged in parallel, as shown in FIG. 2c. However, the presently disclosed subject matter is not limited and the tracks can be arranged in any configuration relative to another track. For example, FIGS. 4a and 4b illustrate tracks 20a and 20b configured perpendicularly and T-shaped relative to each other. However, tracks 20 are not limited to parallel and perpendicular configurations, and can be angled relative to each other, as shown in FIG. 4c. The term “angled” can refer to any angle, such as an acute or obtuse angle. Thus, the tracks can be angled relative to each other or to the horizontal or vertical at least about (or no more than about) 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. Thus, the tracks can be configured in any way that allows for linear movement in at least one direction.

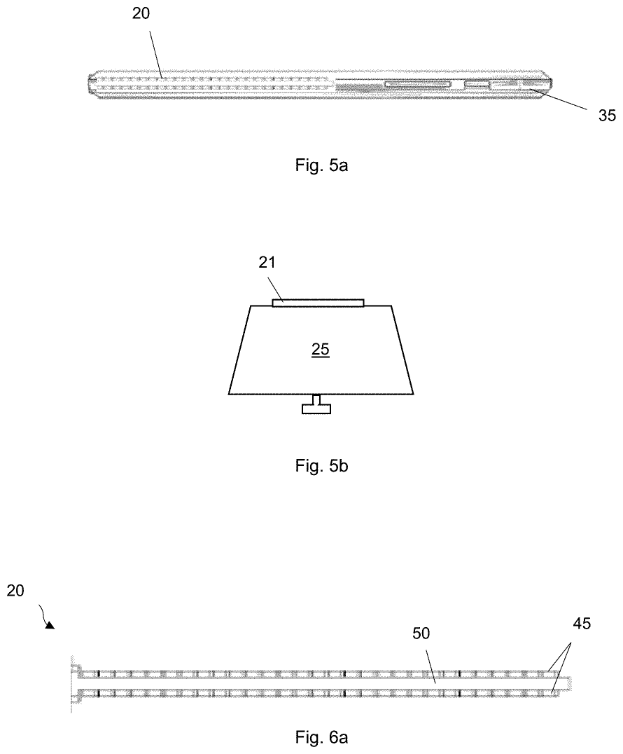

Although depicted on rear face 31 of the case, one or more tracks can be configured on any face of the case. For example, FIG. 5a illustrates one embodiment of case 15 comprising track 20 configured on an outer face of sidewall 35.

In some embodiments, one or more accessories can include track(s) to accessorize the accessories. Particularly, FIG. 5b illustrates one embodiment of accessory 25 comprising accessory track 21. The accessory track allows for the releasable connection of one or more additional accessories.

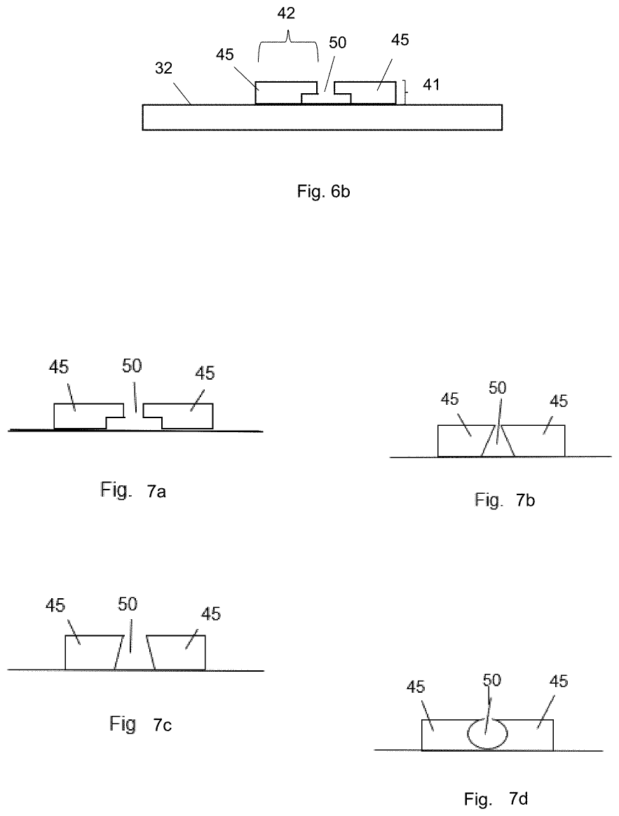

As set forth above, track 20 can include any configuration that provides for the attachment, locking, and release of a desired accessory. As illustrated in FIGS. 6a and 6b, track 20 includes a pair of parallel raised ridges 45 on either side of central groove 50. Each groove provides an opening in track 20 through which a corresponding portion of an accessory is received. In some embodiments, the accessory can move as desired by the user along track 20 to a desired location.

Ridge 45 can have any desired height 41 or width 42, such as about 0.05-1 inches. Thus, each ridge can have a height and/or width of at least about (or no more than about) 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1 inch. However, the presently disclosed subject matter is not limited and the ridge can have a height and/or width greater or smaller than the ranges given herein.

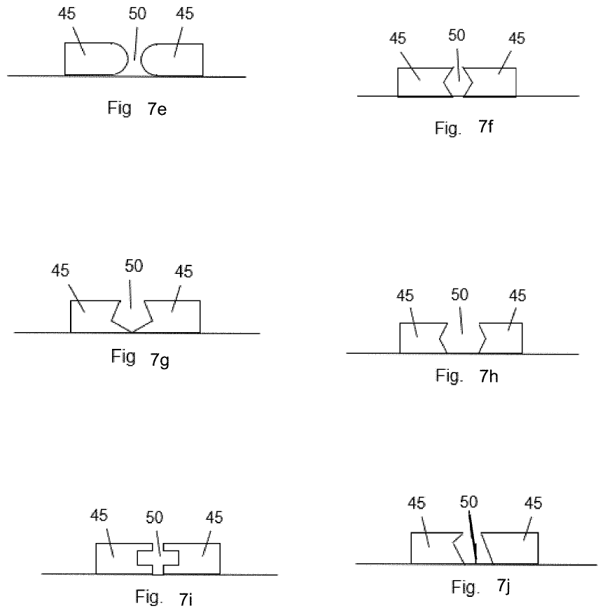

Groove 50 can have any desired cross-sectional shape, such as (but not limited to) a T-shape as shown in FIG. 7a, triangular shape as shown in FIG. 7b, trapezoidal shape as shown in FIG. 7c, rounded shape as shown in FIGS. 7d and 7e, diamond shape as shown in FIG. 7f, pentagonal shape as shown in FIG. 7g, hexagonal shape as shown in FIG. 7h, cross shape as shown in FIG. 7i, or abstract shape as shown in FIG. 7j. It should be appreciated that the cross-sectional shape of groove 50 (and corresponding ridges 45) are not limited and can be configured in any desired shape. In some embodiments, the groove can include at least one tapered side wall. It should further be appreciated that groove 50 can be configured in any length, any width, any depth, and any shape.

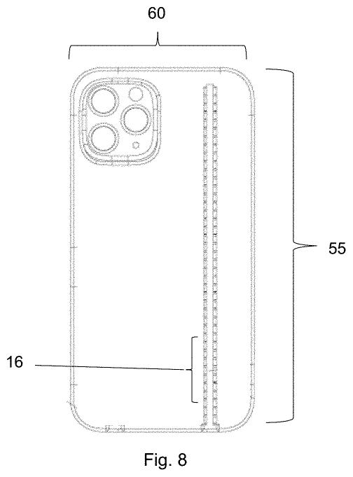

Track 20 can be configured in any desired length and width, depending on the length and/or width of the corresponding device. In some embodiments, track 20 can span approximately the full length 55 and/or width 60 of case 15, as shown in FIG. 8. The term “length” refers to the longest distance in the longitudinal direction. The term “width” refers to the longest distance perpendicular to the length. Alternatively, one or more tracks can span about 10-95 percent the length and/or width of a case. Thus, the track can span at least about (or no more than about) 10, 15, 20, 25, 30, 35, 40, 45, 50, 55, 60, 65, 70, 75, 80, 85, 90, or 95 percent of the length and/or width of case 15.

In some embodiments, the track can include electrical contact area 16 along the at least a portion of the length of the track. The electrical connection can be used to direct power from an electronic accessory to the electronic device, such as an extra battery to charge the electronic device. Alternatively, the electrical contact area can direct power from the electronic device to the accessory to power the accessory. Moreover, the case (using the track system) can direct power from a power source on or within the case to an accessory along the track, bypassing the electronic device all together. In some of the methods described, the electronic accessory can be charged at the same time as the electronic device.

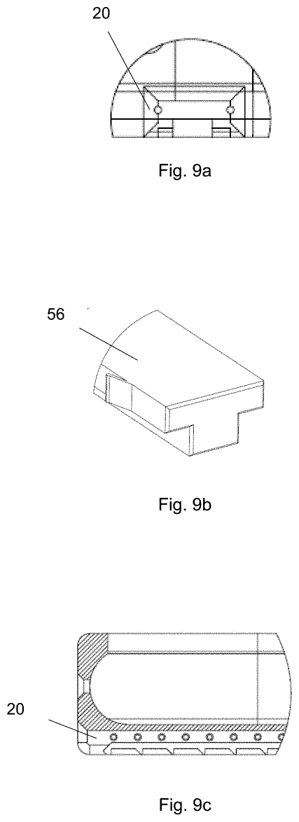

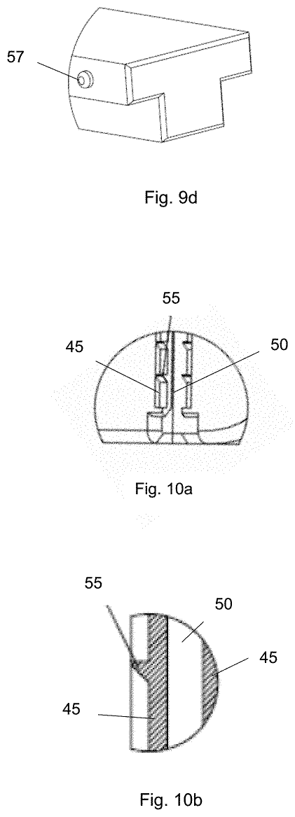

The electrical contact area on the case can be a solid surface along the edge of track 20, where there is a positive and negative contact area for power. The contacts can be in a single track as shown in FIG. 9a or on separate tracks. In some embodiments, the mating shape can include spring-loaded contact 56 where a connection can be made along the track, as shown in FIG. 9b. However, it should be appreciated that the contact is not limited to spring-loaded embodiments, and that any configuration that allows connection to be made along the track can be used. Alternatively, connections can be made at multiple points along track 20 corresponding to locking positions, as shown in FIG. 9c. Optionally, these points can be recessed to protect the contact area and to prevent shorting. The mating shape can have a spring loaded contact 57, similar to an electric pogo pin, that makes contact with the contact area on a track at a specific point, as shown in FIG. 9d. However, it should be appreciated that the male shape can have multiple contacts in any desired configuration.

The contact tracks in both embodiments can be manufactured on a printed circuit board (PCB) and inserted or molded into the case. Optionally, the PCB can also include a microprocessor, Bluetooth® transmitter/receiver, and/or other electrical components to enhance the functionality of the case and the accessories.

The singular contact shown in FIGS. 9a and 9b can provide power, while the individual contacts shown in FIGS. 9c and 9d can provide more functionality (e.g., known positioning of the accessory that is inserted by identifying individual connections rather than a singular one). The connections can provide more than just power; multiple pins can send and receive data or other information through direct connection to the electronic device, similar to a USB that has positive power, negative power, positive data, and negative data. The pins are not limited to the example above and can include any pin out connections (such as a USBC connection, etc.). These connections can allow the electronic device to connect to the case and accessories. It should be noted that the individual pin locations, in the example of the data transmission above, are not limited to a singular point but can be multiple points along the track. This is analogous to a USB strip or similar where multiple accessories can be added to communicate with electronic device.

In some embodiments, when an accessory is inserted into track 20, the rail system along with electronics embedded in the case have the capability of interacting with accessories through sensing, actuation, and/or control to describe and analyze a situation, and make decisions based on the available data in a predictive or adaptive manner, thereby performing smart actions. (see note in claims, I used some verbiage from Wikipedia). In one example, the position can be known and displayed on an app within the electronic device. The app can recognize which accessory has been attached and provide logic or data transmission to and from. For example, if an extra battery was inserted in the track along with chargeable ear phones, the user could instruct the app to automatically engage the battery to charge the phone when the phone gets below 20%, use the phone power to charge the head phones when above 80% or simply turn it on and off when needed. This data transfer has many useful features such as expanding memory, transferring data from the electronic device to an SD card or USB through an accessory, accessing multiple video game cartridges, adding Bluetooth® transmitters to control multiple devices rather than a singular one etc. This could also be used for a docking device connection or connecting a phone to a gaming controller, virtual reality device where the tablet or phone could be used as a screen and external controls, buttons, features could be added.

Each ridge can include one or more recesses 55 that allow an accessory to be locked into place on the track. Specifically, the recesses provide a locking feature at specific set points for attachment of one or more accessories. FIGS. 10a and 10b illustrate one embodiment of ridge 45 comprising a series of recesses 55. The recesses can be uniformly or non-uniformly placed along the length (or a portion of a length) of the ridge. Any number of recesses can be included on a particular ridge. Further, the recesses can be configured in any desired size or shape as desired by the user. As described in detail below, each recess allows a corresponding accessory to be locked into place at a certain location on track 20, allowing for maximum configurability.

In some embodiments, the recesses function similar to a ratchet and pawl mechanism. The term “ratchet” refers to a mechanical device that allows continuous linear or rotary motion in at least one direction, while preventing motion in the opposite direction. The term “pawl” refers to any of a wide variety of curved or shaped bars or levers that include a free end that engages with a ratchet such that the ratchet can move in one direction. As illustrates in the Figures, the ratchet is flat and configured on case 15 and the pawl mechanism is positioned on the accessory. When inserted into track 20, the accessory can freely move in one direction where the locking mechanism inclines on a ramp. At the top of the ramp, the locking mechanism falls to a flat side of the ramp, thereby locking it into place until the locking mechanism is lifted, as illustrated in FIG. 10b. It should be appreciated that the shape of locking mechanism is not limited.

One or more accessories 25 cooperate with tracks 20 to allow customization of case 15. The term “accessory” refers to any desired element that can releasably attach to track 20. Suitable accessories can therefore include (but are not limited to) a wallet, key, key card, keychain, pocket knife, earbuds, writing utensil, medication bottle, coin purse, flashlight, tape measure, photograph frame, notepad, watch, money clip, card holder, laser pointer, tool (screwdriver, bottle opener, tweezers, etc.), and the like. In some embodiments, the accessories can include non-function item(s), such as buttons, pins, patches, and other adornments that allow a user to express his personality or interests. Accessory 25 can therefore include any item capable of attaching to case 15.

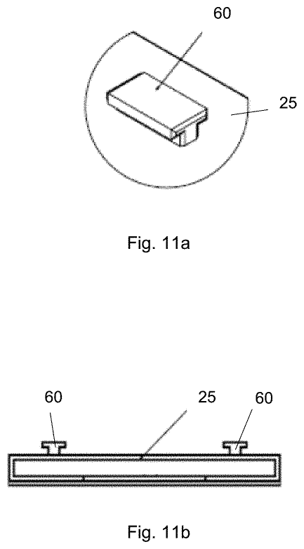

Accessory 25 includes one or more protrusions 60 that cooperates with track 20. Specifically, the protrusion is sized and shaped to fit into track groove 50. For example, FIGS. 11a and 11b illustrate one embodiment of accessory 25 comprising protrusion 60 configured in a “T” shape. Protrusion 60 can be permanently or releasably attached to one surface of the accessory, such as through the use of adhesive, welding, snap-fit attachment, pressure-fit attachment, magnets, hook-and-loop closures, mechanical elements (screws, clips, etc.), and the like.

Protrusion 60 can be configured in any desired size and/or shape, so long as it can be retained within track groove 50. For example, the protrusion can connect to groove 50 via a dovetail connection. However, it should be appreciated that a tapered dovetail connection is only one of many possible connections. In some embodiments, the protrusion can have about the same or slightly smaller size and/or shape as groove 50 to allow for a snug fit when the protrusion is received within the groove. In some embodiments, the protrusion can have a squared shape to prevent rotation of the accessory. Alternatively, the protrusion can have a rounded shape when the user desires to rotate the accessory.

Accessory 25 can be constructed from any desired material, such as (but not limited to) wood, metal, polymeric material, rubber, fabric, or combinations thereof.

Accessories 25 can be arranged on track 20 horizontally and/or vertically. The term “horizontally” refers to any direction parallel to the level floor. The term “vertically” refers to the direction perpendicular to the level floor. The accessories can be configured, added, and/or removed based on the preference of the user in either a horizontal or vertical manner. Specifically, accessories 25 can be positioned at any desired location on track 20 by inserting protrusion 60 into groove 50. As a result, case 15 can be customized with one or more accessories as needed

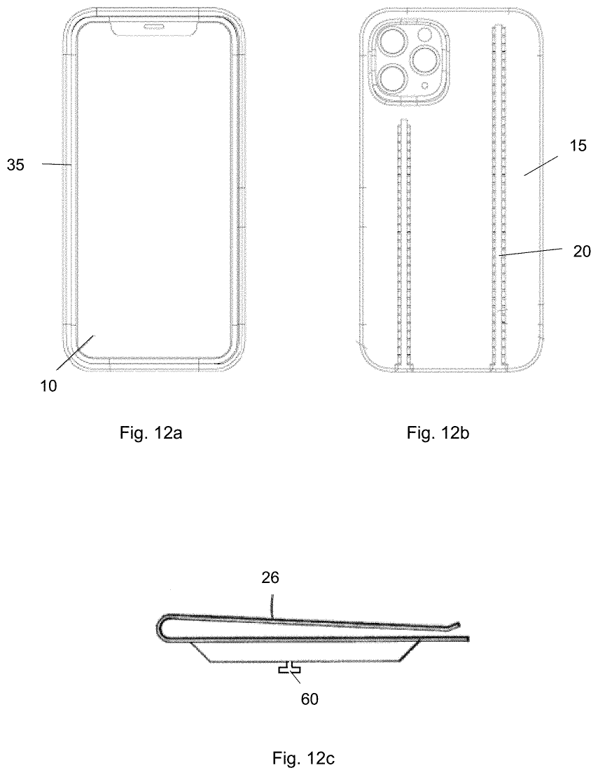

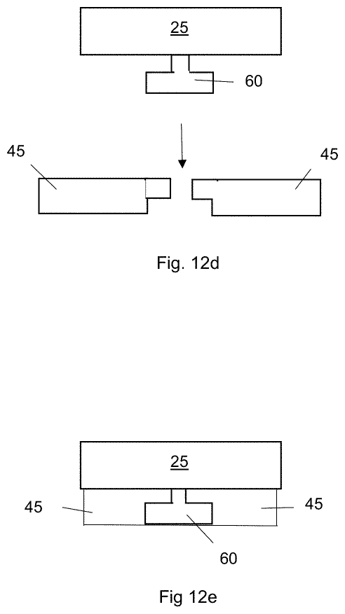

In use, case 15 is configured around a corresponding device 10 using methods well known in the art, as shown in FIGS. 12a and 12b. In some embodiments, the case is constructed from an elastomeric material that allows the case to stretch and adjust about the exterior of the device. In other embodiments, the case is assembled using two or more elements that join together around a corresponding device. As shown, one or more tracks are attached to one surface of cover 15, such as (but not limited to) the back face of the cover.

One or more protrusions 60 are attached to a desired accessory as desired by the user. The protrusion can be permanently attached to the accessory, such as through the use of adhesive, welding, mechanical attachments (e.g., screws, bolts) or molded, machined, and the like so that the protrusions and the accessories are a single piece. Alternatively, the protrusion can be releasably attached to accessory 25, such as through the use of hook-and-loop closures, magnets, clips, and the like. FIG. 12c illustrates one embodiment of an accessory (money clip 26) with attached protrusion 60. The protrusion can be attached to any surface of the accessory.

The protrusion can then be inserted into the groove of a corresponding track, as shown in FIGS. 12d and 12e. The size and shape of the protrusion are accommodated within groove 50. In some embodiments, protrusion 60 and groove 50 have about the same size and shape to provide a snug fit and reliably retain the protrusion within the track system. In some embodiments, the size of the protrusion is slightly smaller than the size of groove 50. As described above, one or more recesses 55 along track 45 are spaced to allow the user to lock accessory 25 into the track. In some embodiments, protrusion 60 is inserted into track 45 at the desired location of recess 55. Optionally, when the protrusion placed in a locked position with respect to the track, there may be an audible sound (e.g., a clicking or snapping sound) to indicate to the user that the accessory is properly locked in place.

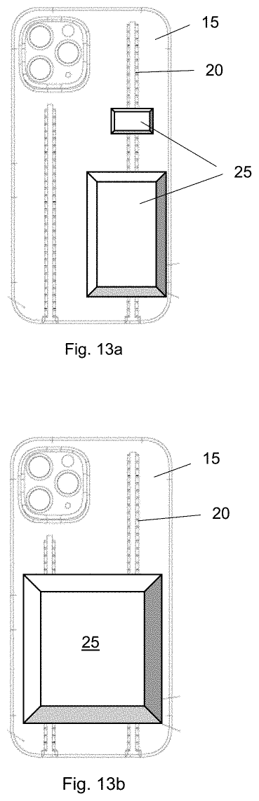

In some embodiments, one or more accessories can be deposited on a single track, as shown in FIG. 13a. Alternatively, one or more accessories can be configured on adjacent tracks, as shown in FIG. 13b. In some cases, the track will be large enough to hold multiple accessories. In such cases, when the track has extra capacity, the track can provide additional storage for more than one accessory.

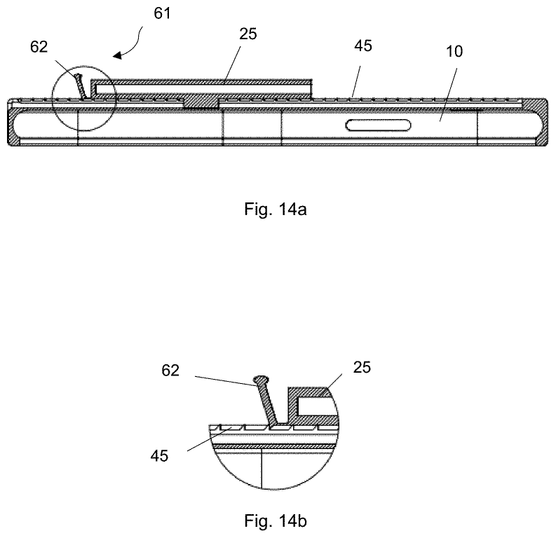

When a user desires to remove the accessory from case 15, he simply unlocks the accessory to remove protrusion 60 from track 50, as shown in FIGS. 14a and 14b. In some embodiments, this can be accomplished by applying light pressure to lock 61 on the accessory where pawl 62 becomes disengaged and allows the accessory to slide to a new position and/or be removed altogether. The term “pawl” can refer to any element that allows an accessory to be removably attached to a track. Further, pawl 62 is not limited to the embodiment shown and can be disengaged by squeezing, pushing, light touch, etc. When pressure is released, the pawl reengages and locks. The lock mechanism is not limited and can include any lock/release design. For example, in some embodiments, the lock can include a spring detent feature that can allow the accessory to slide when pressure is applied to the accessories for easier removal when desired. When pressure is applied, the protrusion is released from recess 55 and track 50. The accessory can then be removed and replaced with a different accessory as needed.

The disclosed case provides many benefits and advantages. For example, the case can be customized with a variety of different accessories, depending on the desires of the user and/or a particular situation.

Case 15 protects device 10 from damage due to accidental dropping or exposure to dirt, liquids, and the like.

The disclosed case increases convenience for the user by providing accessories 25 within easy reach. The user does not have to search a second location to retrieve the accessory.

Because a desired accessory is close at hand on case 15, there is a decreased likelihood that the accessory will become misplaced or lost.

Further, the disclosed case is relatively inexpensive to manufacture, and is safe and easy to use.

In addition, the disclosed case is not limited to a single use. Rather, a wide variety of different uses (and different accessories) can be used with the disclosed case.

Compared to other cases that may include/incorporate one accessory, such as a wallet, this does not limit the case to a singular use and the uses can be interchanged.

In some embodiments, the case can be attached to a mounting device and/or accessory that secures the phone with a mechanical lock, adhesives, elastic, and the like. Particularly, prior art devices typically require the attachment of accessories though the use of adhesives, friction or clamps, and/or elastic elements (e.g., rubber band) around the corners. The disclosed rail system is more secure because it does not rely on adhesives that can degrade friction and do not hold well and/or the use of elastic that is unreliable.

The case could be attached to a mounting device/accessory that better secures the phone with a mechanical lock vs friction, adhesives or elastic means.

The accessories, also containing the rail attachment method, could allow bundling of the accessories together, as to allow separation from the case, while maintain security of the bundle.

In some embodiments, one or more accessories can include a track as described above. Such embodiments allow the bundling of accessories together to allow the accessories to separate from the case, but also maintain security of the bundle.

Accessories could be grouped tougher depending on the user's goals. For example, a daily “accessory pack” could include a wallet, car keys, and a mount. A boating “accessory pack” could include a floatation device, bottle opener and small scissors for cutting fishing line etc.

The disclosed system can provide for the grouping of accessories together as desired by a user. For example, a daily “accessory pack” can be customized to include accessories used on a daily basis (e.g., wallet, car keys, mount). Further, a boating “accessory pack” can include a floating device, bottle opener, scissors, and the like.

The male/lock portion of the attachment method could be attached by any means necessary to any device such as sewn into clothing for runners or glued onto a bike helmet to function similar to a GoPro® camera.

In some embodiments, one end of a chain or rope can be attached to the case (while the other end is attached to the user or another item) to provide an added layer of security, preventing or reducing the likelihood of theft and/or misplacement.

The disclosed case further allows a user to express his personality. Specifically, the user can customize the case with accessories that reflect the user's interests and/or identity.

While the presently disclosed subject matter has been shown and described above, it will be apparent to those skilled in the art that many modifications, additions, and deletions can be made therein without departing from the spirit and scope of the invention.

What is claimed is:

1. A device case comprising:
a body comprising an outer perimeter;
a sidewall attached to and extending about the outer perimeter of the body to define a recess, an inner case wall, and an outer case wall;
a first track attached to the outer case wall, wherein the first track comprises a pair of parallel ridges on either side of a groove;
optionally at least one additional track attached to the outer case wall, wherein the at least one additional track each comprises a pair of parallel ridges on either side of a groove; and
wherein each additional track is independently positioned on the outer case wall relative to the first track;
wherein each ridge comprises a plurality of recesses that allow attachment of an accessory at any desired location along the ridge in both a horizontal orientation and a vertical orientation; and
wherein the groove is sized and shaped to releasably receive a protrusion positioned on the accessory.

2. The device case of claim 1, wherein the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

3. The device case of claim 1, comprising at least one electrical contact area along the at least a portion of the length of the track.

4. The device of claim 3, wherein the at least one electrical contact area can send or receive data through direct connection with the device.

5. The device case of claim 1, wherein the tracks are permanently attached to the outer case wall.

6. The device case of claim 3, wherein the electrical contact area includes at least one contact track manufactured on a printed circuit board, microprocessor, or both.

7. The device case of claim 1, comprising two or more tracks arranged parallel, perpendicularly, or angled relative to at least one other track.

8. The device case of claim 1, wherein the groove has a T, triangular, trapezoidal, round, squared, diamond, pentagonal, hexagonal, cross, or abstract cross-sectional shape.

9. (canceled)

10. A system comprising:
a device case defined by:
a body comprising an outer perimeter;
a sidewall attached to and extending about the outer perimeter of the body to define a recess, an inner case wall, and an outer case wall;
a first track attached to the outer case wall, wherein the first track comprises a pair of parallel ridges on either side of a groove;
optionally at least one additional track attached to the outer case wall,
wherein the at least one additional track each comprises a pair of parallel ridges on either side of a groove, wherein each additional track is independently positioned on the outer case wall relative to the first track;
and wherein each ridge comprises a plurality of recesses that allow attachment of an accessory at any desired location along the ridge in both a horizontal orientation and a vertical orientation;
a protrusion attached to the accessory, wherein the protrusion is sized and shaped to be releasably received within the groove, and wherein interaction between the protrusion and a ridge recess locks the protrusion into position within the groove.

11. The system of claim 10, wherein the device is selected from a cellular phone, smart phone, tablet computer, laptop computer, handheld gaming device, GPS unit, portable music player, gaming console, electronic reader, camera, digital camera, smart watch, personal digital assistant, or combinations thereof.

12. The system of claim 10, comprising at least one electrical contact area along the at least a portion of the length of the track.

13. The system of claim 12, wherein the at least one electrical contact area comprises at least one spring-loaded contact.

14. The system of claim 10, comprising two or more tracks arranged parallel, perpendicularly, or angled relative to at least one other track.

15. (canceled)

16. A method of releasably attaching one or more accessories to a device case, the method comprising:
attaching a protrusion to an accessory to be releasably attached to a device case, wherein the protrusion is sized and shaped to be received within the groove of a device case, wherein the device case comprises:
a body comprising an outer perimeter;
a sidewall attached to and extending about the outer perimeter of the body to define a recess, an inner case wall, and an outer case wall;
a first track attached to the outer case wall, wherein the first track comprises a pair of parallel ridges on either side of a groove;
optionally at least one additional track attached to the outer case wall, wherein the at least one additional track each comprises a pair of parallel ridges on either side of a groove, wherein each additional track is independently positioned on the outer case wall relative to the first track; and
wherein each ridge comprises a plurality of recesses that allow attachment of an accessory at any desired location along the ridge in both a horizontal orientation and a vertical orientation;
removably positioning the protrusion within the groove of the track ridges and locking the protrusion in place on the track via the track recesses for a desired amount of time.

17. The method of claim 16, wherein the groove has a T, triangular, trapezoidal, round, squared, diamond, pentagonal, hexagonal, cross, or abstract cross-sectional shape.

18. (canceled)

19. The method of claim 16, wherein the device case comprises at least one electrical contact area along the at least a portion of the length of the track.

20. The method of claim 19, wherein the at least one electrical contact area comprises at least one spring-loaded contact.

21. The device case of claim 1, comprising at least one track positioned on the case sidewall.

22. The device case of claim 1, wherein the tracks are releasably attached to the cover.

23. The device case of claim 1, wherein for each track the pair of ridges has a first length, and the groove has a length that is greater than the first length.
